(19) United States
(12) Patent Application Publication
(10) Pub. No.: US 2010/0071182 A1
(43) Pub. Date: Mar. 25, 2010

(54) RIVETER

(76) Inventors: Chung-Yen Ho, Taichung City (TW); Ting-Kuo Wu, Taichung City (TW)

Correspondence Address: Muncy, Geissler, Olds & Lowe, PLLC, P.O. BOX 1364, FAIRFAX, VA, 22038-1364, US

(21) Appl. No.: 12/498,620

(22) Filed: Jul. 7, 2009

(30) Foreign Application Priority Data
Sep. 25, 2008 (TW) 97136961

(51) Int. Cl. B23P 11/00

(52) U.S. Cl. 29/243.53

(57) ABSTRACT

A riveter includes a casing having a passageway therein. A shaft is received in the passageway of the casing for a reciprocation motion. Jaws are received in the passageway of the casing to be moved along with the shaft. A spindle is inserted into a rear end the casing to be spun for driving the shaft for the reciprocation motion. The casing is provided with slots on a sidewall of the passageway, and the shaft is provided with recesses aligned with the slots respectively. In each pair of the slot and the recess, at least a ball is received to reduce a friction of the reciprocation motion of the shaft. The riveter of the present further provides an ejector behind the jaws. When a blind rivet is inserted, it will compress the ejector, and the ejector will eject the residual rivet out.

### BACKGROUND OF THE INVENTION

1. Field of the Invention

The present invention relates to a tool and more particularly, to a riveter.

2. Description of the Related Art

Blind rivet is one of the most common fasteners to fasten two objects. Before application of the blind rivet, the objects have to be drilled. A blind rivet is inserted into the drilled holes of the objects, and then, a riveter is used to hold a tail of the blind rivet, and pull the blind rivet to break it that the objects are firmly fastened by the blind rivet.

A conventional riveter usually has jaws to hold the blind rivet, a shaft connected to the jaws for a reciprocation motion, and a spindle to draw the shaft inwards. Such riveter has to connect a power tool. The operator operates the power tool to turn the spindle of the riveter for work.

The conventional riveter usually has a passageway therein for the reciprocation motion of the shaft. The motion, however, of the shaft will generate a friction between the shaft and a sidewall of the passageway. It will affect the action of the riveter. Sometime, it will cause a jam of the shaft as well. Besides, the broken part of the rivet is received in the riveter that it is hard to take it out.

### SUMMARY OF THE INVENTION

The primary objective of the present invention is to provide a rivet, which has a smooth operation.

The secondary objective of the present invention is to provide a rivet, which may take the broken part of the rivet out easily.

To achieve the objective of the present invention, a riveter of the present invention includes a casing having a passageway therein. A shaft is received in the passageway of the casing for a reciprocation motion. Jaws are received in the passageway of the casing adjacent to a front end of the casing to be moved along with the shaft. A spindle has an end inserted into a rear end the casing to be spun for driving the shaft for the reciprocation motion. The casing is provided with slots on a sidewall of the passageway, and the shaft is provided with recesses aligned with the slots respectively. In each pair of the slot and the recess, at least a ball is received to reduce a friction of the reciprocation motion of the shaft.

The riveter of the present further provides an ejector behind the jaws. When a blind rivet is inserted, it will compress the ejector, and the ejector will eject the residual rivet out.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a sectional view along the 3-3 line of FIG. 1;

FIG. 4 is a sectional view along the 4-4 line of FIG. 1; and

FIG. 5 to FIG.7 are sectional view of preferred embodiment of the present invention, showing the operation of the riveter.

### DETAILED DESCRIPTION OF THE INVENTION

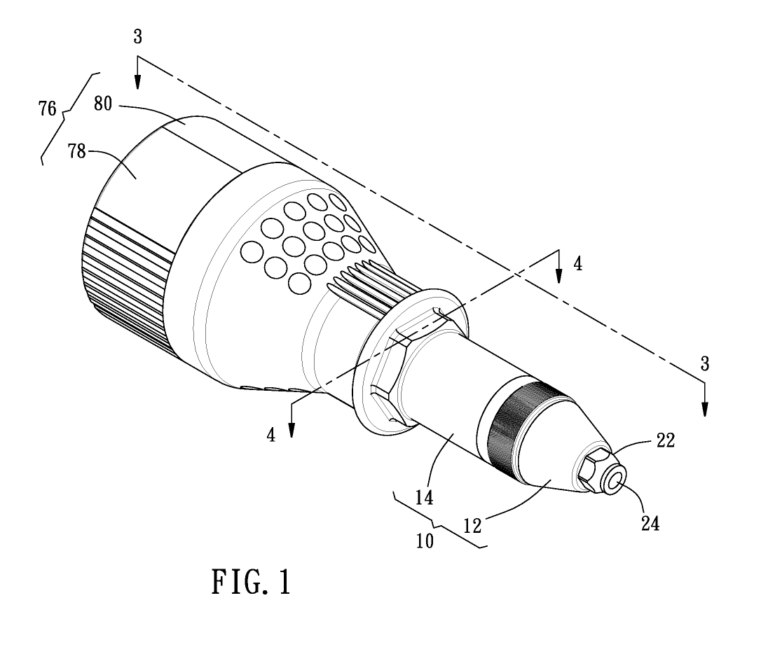

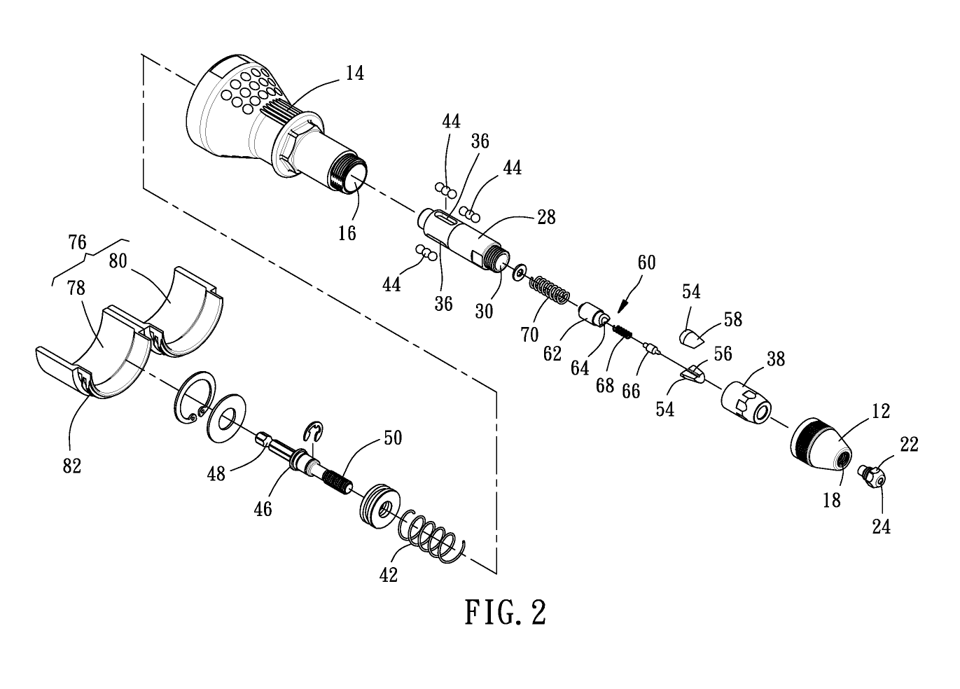

Referring to FIGS. 1 to 3, a riveter of the preferred embodiment of the present invention includes:

A casing 10 includes a head casing 12 and a body casing 14 connected together by threads. The casing 10 has a passageway 16 therein. The passageway 16 has a front opening 18 at a front end and a rear opening 20 at a rear end. A portion of a sidewall of the passageway 16 adjacent to the front opening 18 is provided with an inner thread. A head member 22 has a hole 24 at a center and an outer thread on an outer side. The head member is screwed into the passageway 16 of the casing 10 via the front opening 18 that the hole 24 is communicated with the passageway 16. On the sidewall of the passageway 16 has three slots 26 on three vertex angles of an equilateral triangle.

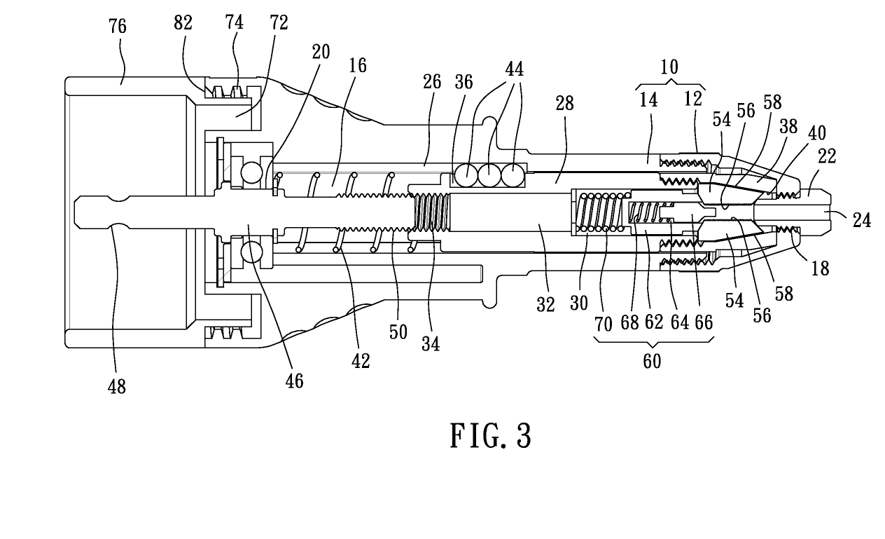

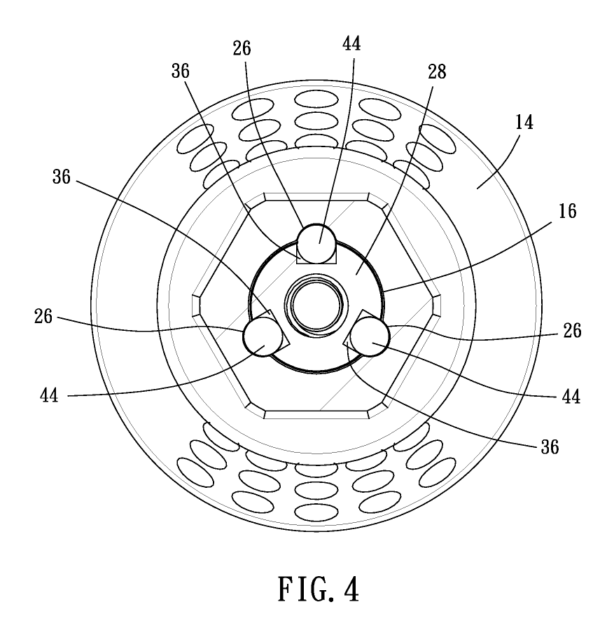

A shaft 28 has a two-order hole including a bigger hole defined as a first hole 30 and a smaller hole defined as a second hole 32. The shaft 28 has a thread on an outer side. The shaft 28 has a threaded hole 34 at a rear end communicated with the second hole 32. The shaft 28 is provided with three recesses 36 on the outer side. A tubular member 38 has an inner thread adjacent to a rear end to be meshed with the outer thread of the shaft 28. The tubular member 38 is provided with a jaw driving portion 40 on an inner side thereof. The shaft 28 and the tubular member 38 are received in the passageway 16 of the casing 10 with the tubular member 38 adjacent to the front end of the casing 10 and the shaft 28 adjacent to the rear end of the casing 10. A spring 42 is received in the passageway 16 of the casing 10 to urge the shaft 28 toward the front end of the casing 10. As shown in FIG. 3, the slots 26 on the casing 10 are aligned with the recesses 36 of the shaft 28 respectively, in each pair of which three balls 44 are received. The balls 44 act like bearing when the shaft 28 reciprocates in the passageway 16 to reduce the friction that the shaft will have a smooth motion in the passageway 16.

A spindle 46 is inserted into the rear opening 20 of the casing 10. An end of the spindle 46 left out of the casing 10 has a connector portion 48 for connection to a power tool (not shown), and the other end thereof in the casing 10 has a threaded section 50 to be meshed with the threaded hole 34 of the shaft 28 when the spindle 46 is spinning to draw the shaft inwards.

Two jaws 54 are received in the tubular member 38, each of which has teeth 56 on an inner side and a cam portion 58 on an outer side. The cam portions 58 of the jaws 54 touch the jaw driving portion 40 of the tubular member 38 that the jaws 54 are moved to each other when the shaft 28 are drawn inwards.

An ejector 60 has a base 62 with a bore 64 at a front end thereof and a block 66 received in the bore 64. A spring 68 is received in the bore 64 also to urge the block 66 outwards. The base 62 is received in the first hole 30 of the shaft 28. A spring 70 is received in the first hole 30 of the shaft 28 to urge the base 62 outwards.

The casing 10 is provided with an annular slot 72 on the rear end thereof around the rear opening 20. On an outer sidewall of the annular slot 72 has a thread 74. A shell 76, which consists of two semicircle pieces 78, 80, has a thread 82 on an outer side adjacent to an end that the shell 76 may be screwed into the annular slot 72 of the casing 10. The shell 76 shields the portion of the spindle 46 left out of the casing and connect the casing 10 and the power tool (not shown) that no turning member, which may cause danger, is exposed when the riveter of the present invention is connected to the power tool for operation.

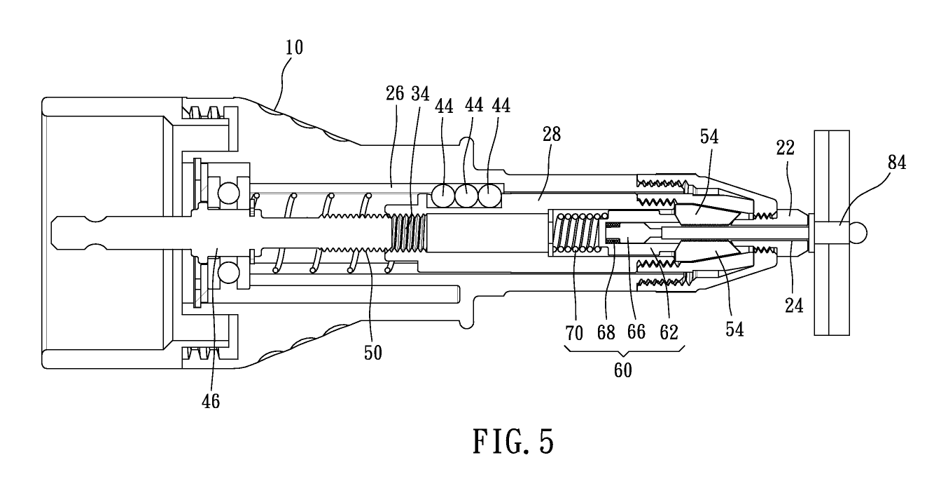

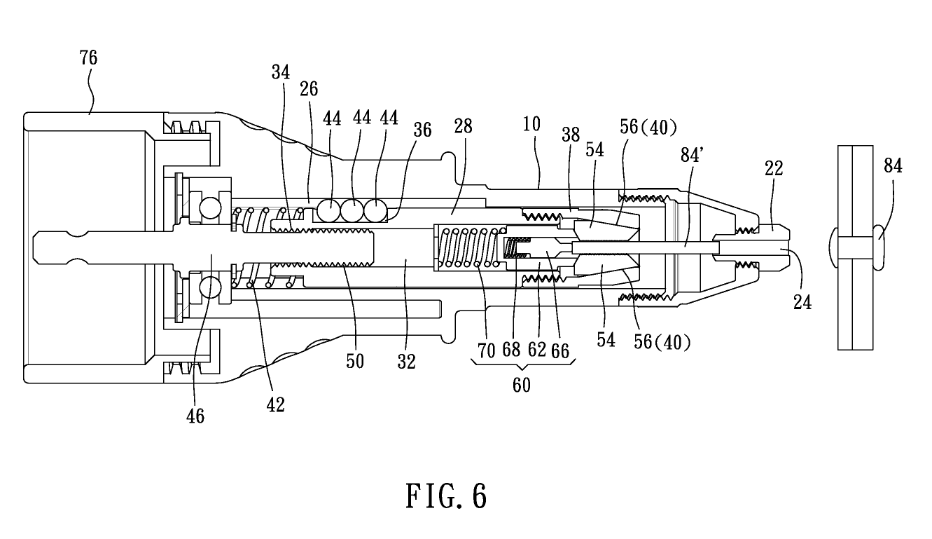

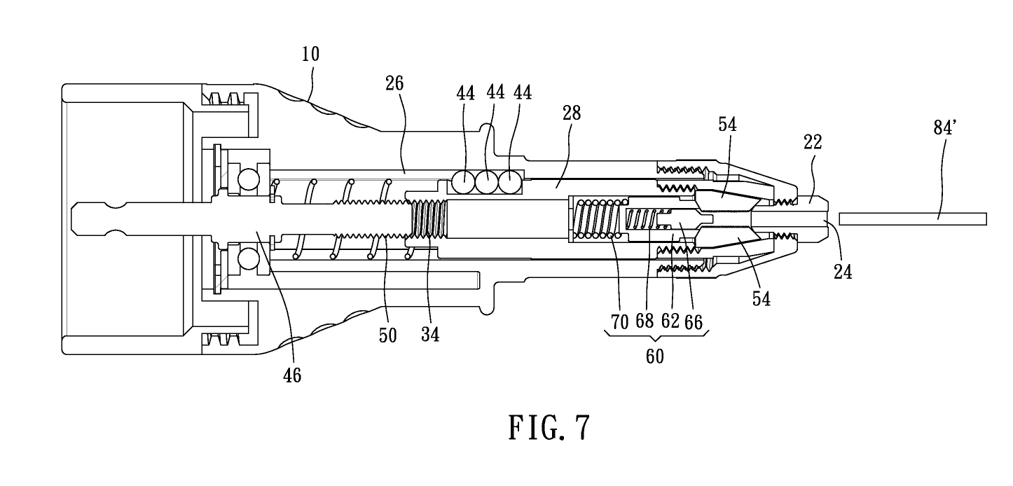

As shown in FIG. 5, a blind rivet 84 is inserted into the hole 24 of the head member 22, passing the jaws 54, and moving the block 66 of the ejector 60 backward to compress the spring 68. When the spindle 46 is spun by the power tool (not shown), with an interaction of the threaded section 50 of the spindle 46 and the threaded hole 34 of the shaft 28, the shaft 38, together with the tubular member 38, the jaws 54, and the ejector 60, are drawn inwards. In the meantime, the jaws 54 are moved to each other by the jaw driving portion 40 to hold the blind rivet 84 tightly. As the power tool keeps spinning the spindle 46, the blind rivet will be elongated, and broken at last. At this moment, the threaded section 50 of the spindle 46 will go through the threaded hole 34 of the shaft 38 and enter the second hole 32 that the threaded section 50 is not meshed with the threaded hole 34, and the spindle 46 is spinning still but cannot move the shaft 28. After that, the power tool is switched the spinning direction to drive the spindle 46 spinning reversely. The threaded section 50 is meshed with the threaded hole 34 again to move the shaft 28 outwards that the jaws 54 will loose a residual rivet 84′. In the meantime, the spring 68 will urge the block 66 outwards to eject the residual rivet 84′ out, as shown in FIG. 7.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A riveter, comprising:
a casing having a passageway therein;
a shaft received in said passageway of said casing for a reciprocation motion;
jaws received in said passageway of said casing adjacent to a front end of said casing to be moved along with said shaft; and
a spindle having an end inserted into a rear end said casing to be spun for driving said shaft for the reciprocation motion;
wherein said casing is provided with slots on a sidewall of said passageway, and said shaft is provided with recesses aligned with said slots respectively, and in each pair of said slot and said recess, at least a ball is received to reduce a friction of the reciprocation motion of said shaft.

2. The riveter as claimed in claim 1, further comprising an ejector received in said passageway of said casing behind said jaws, wherein said ejector includes a block and a spring urging said block outwards.

3. The riveter as claimed in claim 2, wherein said ejector further includes a base having a bore, in which said block and said spring are received.

4. The riveter as claimed in claim 3, wherein said shaft has a first hole, in which said base is received, and a spring received in said first hole to urge said base outwards.

5. The riveter as claimed in claim 1, further comprising a shell connected to the rear end of said casing to enclose a portion of said spindle left out of said casing.

6. The riveter as claimed in claim 5, wherein said casing is provided with an annular slot on said rear end thereof which has a thread on a sidewall thereof, and said shell has a thread that an end of said shell is inserted into said annular slot to mesh said thread thereof with said thread on said sidewall of said annular slot.

7. The riveter as claimed in claim 5, wherein said shell includes two semicircle pieces.

8. The riveter as claimed in claim 1, wherein said shaft has a threaded hole at a rear end thereof, and said spindle has a threaded section to be meshed with said threaded hole of said shaft.
